(19) United States
(12) Patent Application Publication
(10) Pub. No.: US 2008/0127121 A1
(43) Pub. Date: May 29, 2008

(54) SOFTWARE REGRESSION FACILITY

(75) Inventors: Oliver Fenton, Hampshire (GB); Anthony Paul Beardsmore, Southampton (GB); Dale Lane, Hampshire (GB)

Correspondence Address: AKERMAN SENTERFITT, P.O. BOX 3188, WEST PALM BEACH, FL, 33402-3188, US

(73) Assignee: INTERNATIONAL BUSINESS MACHINES CORPORATION, Armonk, NY (US)

(21) Appl. No.: 11/938,574

(22) Filed: Nov. 12, 2007

(30) Foreign Application Priority Data
Nov. 23, 2006 (GB) 0623333.2

(51) Int. Cl. G06F 9/44

(52) U.S. Cl. 717/131

(57) ABSTRACT

A method of a regression manager for providing a regression operation to a software application executable in a computer system, the method comprising the steps of: receiving registration information for a regression callback function from a software application, the regression callback function providing a regression facility for the software application; receiving an action parameter for a regressable action from the software application, the action parameter comprising an argument for use by the regression callback function to regress the regressable action; and in response to a request to provide a regression operation for the software application, calling the regression callback function for the software application.

### CROSS-REFERENCE TO RELATED APPLICATION

This application claims the benefit of British Patent Application No. 0623333.2, filed on Nov. 23, 2006, which is incorporated herein by reference in its entirety.

### FIELD OF THE INVENTION

The present invention relates to facilitating regression operations to software applications executable in a computer system, and more particularly, to providing a system-wide regression facility.

### BACKGROUND

Individual software applications frequently provide a facility to regress, or undo, a user action. Such regression facilities are useful in the event that a user has performed an action by mistake, or changes their mind regarding a previously-executed action. Such a regression facility can be initiated by a user and is operable to revert a software application to a state which existed before a regressable action was performed.

For example, word processing software applications can include an “undo” option that will regress a most recently taken user action. Software applications can also retain a list of multiple regressable actions which a user can regress individually, one at a time, or as a set or subset. Since the state of a software application changes with each user action performed in sequence, regression of such user actions will normally be required to take place in a sequence which is the reverse of that sequence in which the actions were performed. For this reason, lists of multiple regressable actions will normally be stored in an ordered data structure.

While the provision of a regression facility in an individual software application is useful, it has the drawback that regression of actions is specifically designed and developed into each software application individually. This involves much duplication of effort in recording each and every user action separately within each software application. Furthermore, a regression facility existing entirely within a software application is operable to regress actions only during the execution of that software application. It is conceivable that a user undertakes an action within a software application before exiting the application. Regression of such an action will not be possible following the exiting of the application because the exit from the application inherently includes the closing of the regression facility.

It would therefore be advantageous to overcome these disadvantages by providing that a regression facility need not be provided in each and every software application, and to provide for a regression facility which is operable outside the scope of any one application.

### SUMMARY OF THE INVENTION

The present invention accordingly provides, in a first aspect, a method of a regression manager for providing a regression operation to a software application executable in a computer system. The method can include the steps of: receiving registration information for a regression callback function from a software application, the regression callback function providing a regression facility for the software application: receiving an action parameter for a regressable action from the software application, the action parameter comprising an argument for use by the regression callback function to regress the regressable action; and in response to a request to provide a regression operation for the software application, calling the regression callback function for the software application.

In this way a centralized regression manager is operable to provide a regression facility for multiple applications suitable for execution on a computer system. Both the recording of information for regressable actions in a data structure, and the triggering of the regression operation using the registration information are undertaken externally to software applications themselves. Further, the specific implementation of the regression functionality is provided within each software application as a regression callback function, allowing the regression manager to be generalized without specific knowledge of how each action or regression is implemented. Additionally, since the regression facility exists logically separate from the software applications it is possible to regress actions even after the software application ceases to execute. For example, the regression stack can include entries for a software application which persist after the execution of the software application has ceased.

The method can further include storing each of the action parameters associated with an identifier of the software application in a data structure ordered according to the order of receipt of action parameter.

The calling the regression callback step can further include sending an argument of a most recent of the action parameters associated with the software application.

The method can further include removing the most recent of the action parameters associated with the software application from the data structure.

The regression manager can be incorporated into an operating system of the computer system.

The data structure can be a stack data structure.

The stack can be stored in a memory of the computer system.

The stack can be stored in a non-volatile memory of the computer system such that action parameters are persistent.

A request to provide a regression operation can originate from a source logically separated from the software application.

The present invention accordingly provides, in a second aspect, a regression manager apparatus for providing a regression operation to a software application executable in a computer system. The apparatus can include: a first receiver for receiving registration information for a regression callback function from a software application, the regression callback function providing a regression facility for the software application: a second receiver receiving an action parameter for a regressable action from the software application, the action parameter comprising an argument for use by the regression callback function to regress the regressable action; and a function caller for, in response to a request to provide a regression operation for the software application, calling the regression callback function for the software application.

The present invention accordingly provides, in a third aspect, an apparatus comprising: a central processing unit, a memory subsystem; an input/output subsystem; and a bus subsystem interconnecting the central processing unit, the memory subsystem, the input/output subsystem; and the regression manager apparatus described above.

The present invention accordingly provides, in a fourth aspect, a computer program element, or computer-readable medium, comprising computer program code that, when loaded into a computer system and executed thereon, causes the computer to perform the steps of a method as described above.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a block diagram of a computer system suitable for the operation of embodiments of the present invention;

FIG. 2 is a block diagram of a regression manager for multiple software applications in accordance with a preferred embodiment of the present invention;

FIG. 3a is a flowchart of a method in accordance with a preferred embodiment of the present invention;

FIG. 3b is a flowchart of a method of the regression operation of FIG. 2 in accordance with a preferred embodiment of the present invention;

FIG. 4 is a block diagram illustrating an exemplary software application ‘A’ and an exemplary software application ‘B’ for use with the regression manager of FIG. 2 in accordance with a preferred embodiment of the present invention;

FIG. 5 is a first state diagram of the software applications of FIG. 4 in use with the regression manager of FIG. 2 to add actions to the regression stack of the regression manager in accordance with a preferred embodiment of the present invention;

FIG. 6 is block diagram of the regression manager of FIG. 2 in use for the software applications of FIG. 4 following the operations of the state diagram in FIG. 5 in accordance with a preferred embodiment of the present invention:

FIG. 7 is a second state diagram of the software applications of FIG. 4 in use with the regression manager of FIG. 2 to regress actions in the regression stack in accordance with a preferred embodiment of the present invention;

FIG. 8a illustrates a transition of the regression stack of FIG. 6 during a regression of a first action in FIG. 7 in accordance with a preferred embodiment of the present invention;

FIG. 8b schematically illustrates a transition of the regression stack of FIG. 6 during a regression of a second action in FIG. 7 in accordance with a preferred embodiment of the present invention; and

FIG. 8c schematically illustrates a transition of the regression stack of FIG. 6 during a regression of a third action in FIG. 7 in accordance with a preferred embodiment of the present invention.

### DETAILED DESCRIPTION

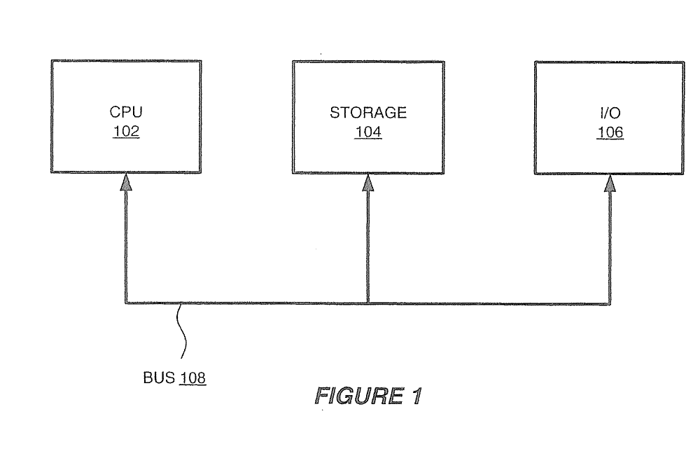

FIG. 1 is a block diagram of a computer system suitable for the operation of embodiments of the present invention. A central processor unit (CPU) 102 is communicatively connected to a storage 104 and an input/output (I/O) interface 106 via a data bus 108. The storage 104 can be any read/write storage device such as a random access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

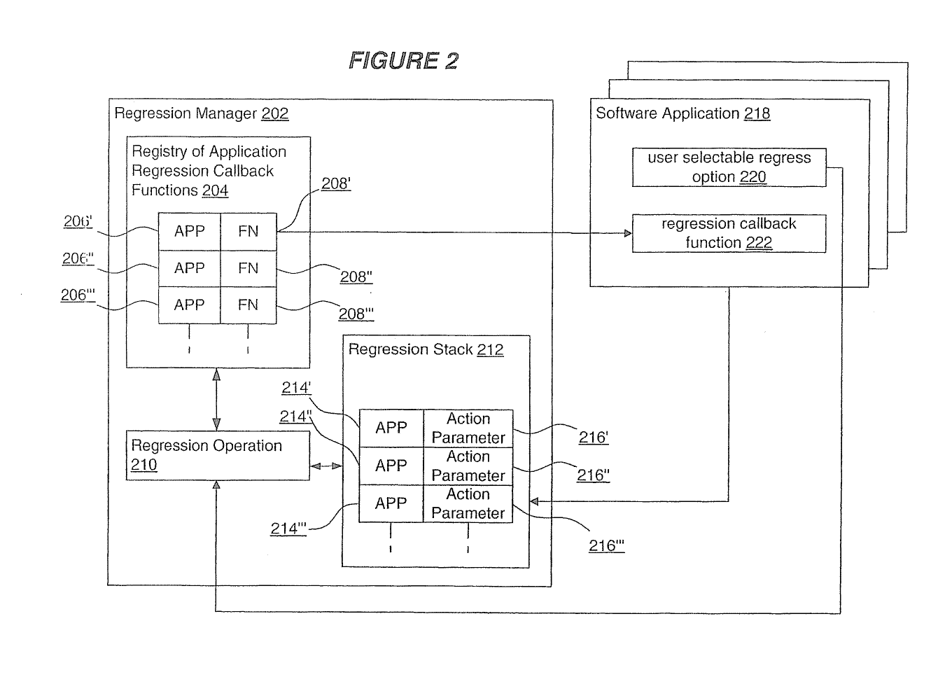

FIG. 2 is a block diagram of a regression manager 202 for multiple software applications 218 in accordance with a preferred embodiment of the present invention. The regression manager 202 is a software or hardware component for cooperating with, and providing regression facilities to, multiple software applications 218. For example, the regression manager 202 is a software service implemented as part of an operating system executing on a computer system. Alternatively, the regression manager 202 constitutes an integral part of the operating system, or a supplementary feature selectably included in the operating system. As a further alternative, the regression manager 202 is implemented as a separate software application executing in cooperation with the operating system and the software applications 218. In one embodiment, the software applications 218 are distributed across multiple, communicatively connected, computer systems, and the regression manager 202 is implemented on one of the computer systems, or on a disparate, but communicatively connected, computer system dedicated to providing facilities including regression.

The regression manager 202 includes a registry of application callback functions 204. The registry 204 comprises a data structure containing an entry for each of the software applications 218 for which a regression facility is provided by the regression manager 202. For example, the registry 204 can comprise a list, table or database. Each entry in the registry 204 includes an application identifier 206′, 206″, 206″′. Each application identifier 206′, 206″, 206″′ is a unique identifier for one of the software applications 218 to which regression facilities are provided. For example, the application identifier 206′, 206″, 206″′ can comprise a unique name or reference number for an application. Each entry in the registry 204 further includes a reference 208′, 208″, 208″′ to a regression callback function 222 in the software application corresponding to an application identifier 206′, 206″, 206″′. A regression callback function 222 is an application-specific function for implementing an application-specific regression for a user action in the application. For example, in a word processing application, a user action of typing the words “once upon a time” can be regressed by removal of the words “once upon a time”. A regression callback function 222 in such a word processing application is operable to receive, as an argument, the user action (i.e. the typing of the words “once upon a time”) and to regress that action (i.e., by removal of those words). Since each software application can provide potentially vastly different user actions, and can define correspondingly vastly different regression operations for such user actions, it is necessary that each of the software applications 218 provide a regression callback function 222 to undertake such application specific regressions. Such regression functions are well known in the art and are currently included in applications providing a regression facility, such as an ‘undo’ facility. The reference 208 to the regression callback function 222 is preferably a memory reference, such as a function pointer, to the regression callback function 222 in a software application.

The regression manager 202 further includes a regression stack 212. The regression stack 212 comprises an ordered data structure including an entry for each user action added by a software application. Each entry in the regression stack 212 corresponds to a user action in a software application which is regressable by a regression callback function 222 for the software application. Each entry in the regression stack 212 includes a unique application identifier 214′, 214″, 214″′ corresponding to an application identifier 206′, 206″, 206″′ stored in the registry 204. Each entry in the regression stack 212 further includes an action parameter 216′, 216″, 216″′. Each action parameter 216′, 216″, 216″′ is a parameter provided by a software application 218 for a particular user action in the software application. Each action parameter 216′, 216″, 216″′ is a representation of a regressable user action including an argument suitable for sending to a regression callback function 222 of the software application for regressing the action. The format of the action parameter 216 can be application specific and it is not necessary for the regression manager 202 to be able to interpret or understand the action parameter 216. In one embodiment, an action parameter 216′, 216″, 216″′ is a stream of bytes including user action information as an argument for an application regression callback function 222.

An action parameter 216′, 216″, 216″′ can include information relating to a state of the software application both before and after a user action is complete. For example, a user action in a file manager application to rename a file from the name “a.txt” to the name “b.txt” may be represented by an action parameter 216′ including details of the user action (i.e. a file rename action) and the state of the file before and after the action (i.e. the original name “a.txt” and the new name “b.txt”). This information is then useful by a regression callback function 222 to regress the user action. Such a regression can include, for example, renaming the file back to its original name of “a.txt”. Without the state information before and after the user action, the regression callback function 222 would be unable to determine what the file should be renamed to in an effective regression.

The regression manager 202 receives action parameters 216′, 216″, 216″′ from the software applications 218 and adds them to the regression stack 212 along with an identifier 214′, 214″, 214″′ of the particular originating application. Entries in the regression stack 212 are ordered according to the order of receipt of action parameters 216′, 216″, 216″′ from software applications.

While the regression stack 212 is described as a stack, it will be apparent to those skilled in the art that the regression stack 212 can alternatively be implemented using any ordered data structure such as an ordered list, table or database. Furthermore, in one embodiment the regression stack 212 has a limited size to reflect a limit to the number of regressable actions included in the regression stack 212. When the regression stack 212 reaches the size limit, the receipt of a new action parameter from a software application for addition to the regression stack 212 will cause the deletion of an oldest action parameter on the regression stack 212 to prevent exceeding the size limit. In one example of such an embodiment, the oldest action parameter for deletion from the regression stack 212 is selected as the oldest action parameter associated with the unique identifier of the software application for which a new action parameter is received.

In one embodiment, the regression stack 212 is stored in a memory of a computer system. In an alternative embodiment, the regression stack 212 is stored in a non-volatile storage of the computer system in order that the regression stack 212 can persist beyond the operation of the computer system.

The regression manager 202 further includes a regression operation 210 as a functional software or hardware component responsive to the selection of a user selectable regress option 220 in a software application. The user selectable regress option 220 is useful to trigger, by, for example, a user, the regression of a most recent user action in a software application. The user selectable regress option 220 can alternatively be provided logically separated from the software application, for example as part of a user interface for the operating system, as part of a separate software application or as part of a user interface associated with the regression manager 202. Once triggered, the regression operation 210 is operable to receive an application identifier for which a regression operation is required. The application identifier is associated with an application for which the user selectable regress option 220 is selected. The regression operation 210 then locates the most recent action parameter entry in the regression stack 212 for the identified application and calls the regression callback function 222 for the identified application sending an argument from the located action parameter. The regression callback function 222 is called via the registry 204 which includes a reference to the regression callback function 222 for the identified application. Subsequently, the regression operation 2110 removes the located action parameter 216 entry from the regressions stack 212. This removal is required as once an action parameter is regressed it cannot be further regressed and so must be removed as the latest action parameter 216 in the regression stack 212.

In this way a centralized regression manager 202 is operable to provide a regression facility for multiple applications suitable for execution on a computer system. Both the recording of information for regressable actions in the regression stack 212, and the triggering of the regression operation via the registry 204, are undertaken externally to software applications 218. Further, the specific implementation of the regression functionality is provided within each software application as a regression callback function 2 allowing the regression manager 202 to be generalized without specific knowledge of how each action or regression is implemented. Additionally, since the regression facility exists logically separated from the software applications 218 it is possible to regress actions even after the software application ceases to execute. For example, the regression stack 212 can include entries for a software application which persist beyond the execution of the software application. Further, the inclusion in the registry 204 of entries for software applications from which other software applications can be invoked (such as the Explorer application in Microsoft Windows (Windows is a Registered Trademark of the Microsoft Corporation)) will allow actions including the invocation and closing of applications to also be susceptible to regression. In this way, application management actions and operating system actions, including the very act of closing an application, can be regressed.

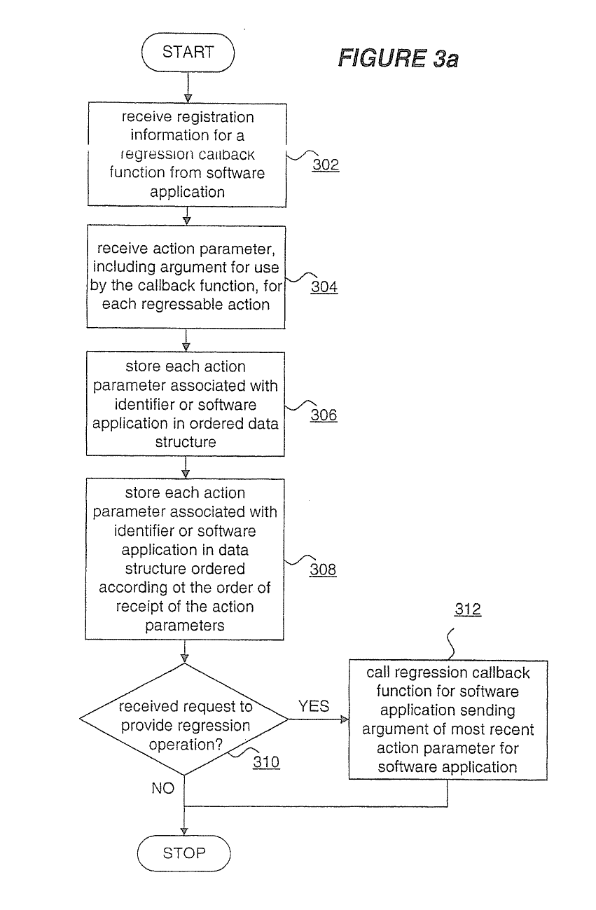

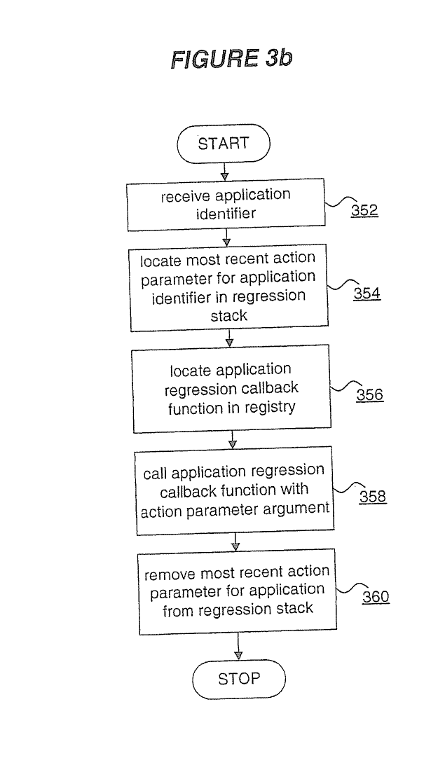

FIG. 3a is a flowchart of a method of the regression manager 202 of FIG. 2 in accordance with a preferred embodiment of the present invention. Initially, at step 302, registration information for a regression callback function 222 is received from one of a plurality of software applications 218 by the regression manager 202. The registration information comprises a reference to the regression callback function 222 and a unique identifier for the software application. The registration information is used by the regression manager 202 to create an entry for the software application in the registry 204. Subsequently, at step 304, the regression manager 202 receives action parameters 216′, 216″, 216″′ for regressable user actions from software applications 218 including, for each action parameter, a unique identifier of the software application 218 from which the action parameter originates. The regression manager 202 stores, at step 308, each action parameter and corresponding application identifier in the regression stack 212 in the order in which they are received. In this way, the method maintains an ordered record of regressable user actions in the regression stack 212. Subsequently, at step 310, the method is responsive to a request to provide a regression operation for a specific one of the software applications 218. In response to such a request, the method calls the regression callback function 222 for the specific software application sending an argument of a most recent of the action parameters 216 received for the software application.

FIG. 3b is a flowchart of a method of the regression operation 210 of FIG. 2 in accordance with a preferred embodiment of the present invention. The method of FIG. 3b is responsive to the selection of the user selectable regress option 220 for a specific application. Initially, at step 352, the regression operation 210 receives an application identifier from the application. The received application identifier is used to locate an appropriate regression callback function 222 in the registry 204, and a most recent action parameter in the regression stack 212. At step 354 the regression operation 210 locates a most recent entry in the regression stack 212 for the application identifier, and identifies the action parameter for that entry. The located action parameter will correspond to the most recent user action in the application for which the user selectable regress option 220 was selected. At step 356 the regression operation 210 locates a reference to a regression callback function for the application identifier in the registry 204. Subsequently, at step 358, the regression operation 210 calls the located application callback function 222 with an argument from the identified action parameter. When called, the application callback function 222 operates to regress the action corresponding to the action parameter argument, potentially in an application specific manner. Finally, at step 360, the method removes the most recent entry in the regression stack 212 for the application identifier. The removal of the most recent entry in the regression stack 212 provides that the regressed action is no longer represented on the regression stack 212, and accordingly is no longer available for regression (since it has been regressed).

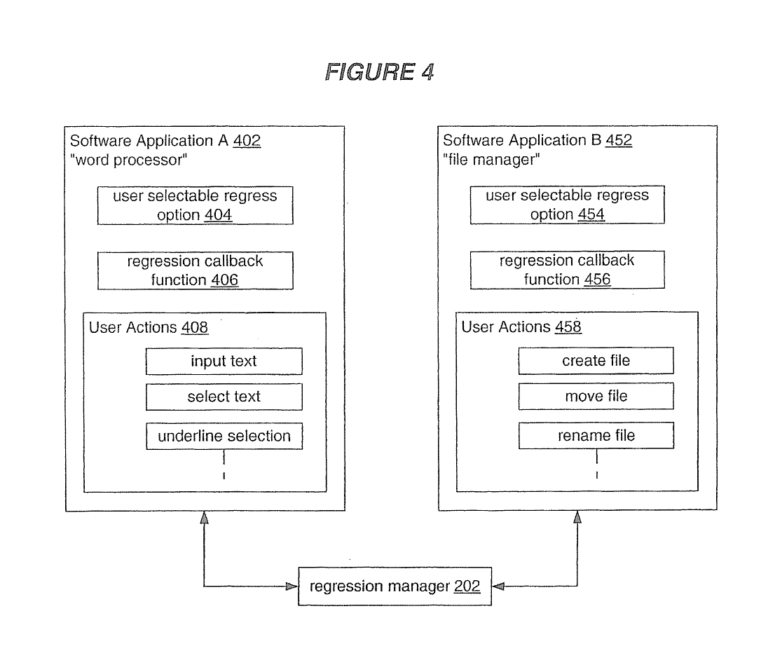

FIG. 4 is a block diagram illustrating an exemplary software application ‘A’ 402 and an exemplary software application ‘B’ 452 for use with the regression manager 202 of FIG. 2 in accordance with a preferred embodiment of the present invention. Software application ‘A’ 402 is nominally a word processor application and includes: a user selectable regress option 404 such as an ‘undo’ option; and a regression callback function 406 which provides application specific regression functionality for a given action parameter. An exemplary and non-exhaustive list of possible user actions 408 are also included in software application ‘A’ 402 including: an ‘input text’ action corresponding to a user typing text into a word processing document; a ‘select text’ action corresponding to a user selecting text in the word processing document, such as by using a pointing device to select text; and an ‘underline selection’ action corresponding to a user requesting that the style of a selected portion of text is supplemented to include underlining. It will be apparent to those skilled in the art that the list of user actions 408 is merely illustrative and that an actual list of possible user actions for a software application such as a word processor could be substantially greater in number and complexity. The regression callback function 406 is operable to regress any of the user actions 408. For example, the regression callback function 406 is operable to regress an ‘input text’ action by, for example, removing inputted text. Similarly, the regression callback function 406 is operable to regress a ‘select text’ action by, for example, deselecting a selected portion of text.

FIG. 4 further includes software application ‘B’ 452 which is nominally a file manager application and includes: a user selectable regress option 454 such as an ‘undo’ option; and a regression callback function 456 which provides application specific regression functionality for a given action parameter. An exemplary and non-exhaustive list of possible user actions 458 are also included in software application ‘B’ 452 including: a ‘create file’ action corresponding to a user creating a new file; a ‘move file’ action corresponding to a user moving a file, such as by moving a file within a file system from one directory to another director; and a ‘rename file’ action corresponding to a user requesting to rename a file. It will be apparent to those skilled in the art that the list of user actions 458 is merely illustrative and that an actual list of possible user actions for a software application such as a file manager could be substantially greater in number and complexity. The regression callback function 456 is operable to regress any of the user actions 458. For example, the regression callback function 456 is operable to regress a ‘move file’ action by, for example, returning a moved file from its destination directory to its original directory. Similarly, the regression callback function 456 is operable to regress a ‘rename file’ action by, for example, returning a name associated with a file from its changed value to its original value.

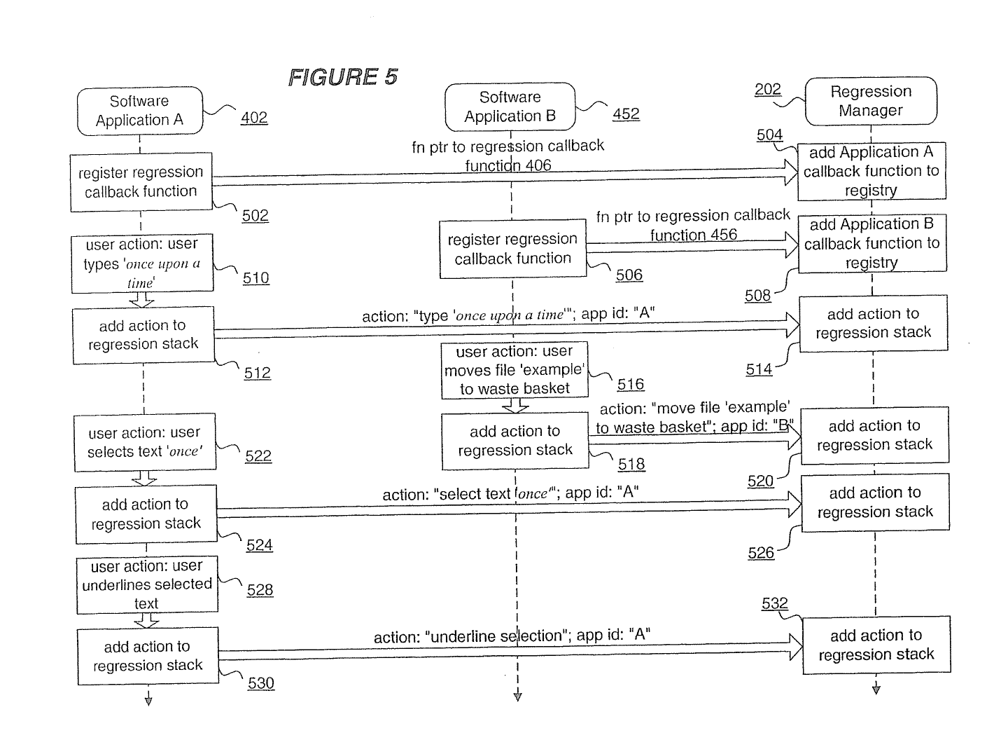

FIG. 5 is a first state diagram of the software applications ‘A’ 402 and ‘B’ 452 of FIG. 4 in use with the regression manager 202 of FIG. 2 to add actions to the regression stack 212 of the regression manager 202 in accordance with a preferred embodiment of the present invention. Initially, at 502, software application ‘A’ 402 registers its regression callback function 406 with the regression manager 202 by providing a function pointer to the regression callback function 406 and a unique identifier of software application ‘A’ 402. At 504 the regression manager adds 202 the application identifier of software application ‘A’ 402 and the function pointer to the regression callback function 406 to the registry 204.

Similarly, at 506, software application ‘B’ 452 registers its regression callback function 456 with the regression manager 202 by providing a function pointer to the regression callback function 456 and a unique identifier of software application ‘B’ 452. At 508 the regression manager 202 adds the application identifier of software application ‘B’ 452 and the function pointer to the regression callback function 456 to the registry 204.

Subsequently, at 510, the user performs an ‘input text’ action by typing the text “once upon a time” in software application ‘A’ 402. At 512 software application ‘A’ 402 collaborates with the regression manager 202 to add the user action to the regression stack 212 by supplying the regression manager 202 with an action parameter 216 ‘input text “once upon a time”’ and an application identifier for software application ‘A’ 402. At 514 the regression manager adds the action parameter and application identifier to the regression stack 212.

Subsequently, at 516, the user performs an ‘move file’ action in software application ‘B’ 452 by moving a file named “example” to a waste basket in the application. At 518 software application ‘B’ 452 collaborates with the regression manager 202 to add the user action to the regression stack 212 by supplying the regression manager 202 with an action parameter ‘move file “example” from an “original location” to “waste basket”’ and an application identifier for software application ‘B’ 452. At 520 the regression manager adds the action parameter and application identifier to the regression stack 212.

Subsequently, at 5229, the user performs a ‘select text’ action by selecting the text “once” in software application ‘A’ 402. At 524 software application ‘A’ 402 collaborates with the regression manager 202 to add the user action to the regression stack 212 by supplying the regression manager 202 with an action parameter 216 ‘select text “once”’ and an application identifier 214 for software application ‘A’ 402. At 526 the regression manager adds the action parameter 216 and application identifier 214 to the regression stack 212.

Finally, at 528, the user performs an ‘underline selection’ action by performing an underline function on the selected text in software application ‘A’ 402. At 530 software application ‘A’ 402 collaborates with the regression manager 202 to add the user action to the regression stack 212 by supplying the regression manager 202 with an action parameter ‘underline selection’ and an application identifier for software application ‘A’ 402. At 532 the regression manager adds the action parameter and application identifier to the regression stack 212.

In this way it can be seen how the exemplary software applications ‘A’ 402 and ‘B’ 452 are able to register with the regression manager 202 to have regression callback functions 406 and 456 listed in the registry 204 of the regression manager, and add action parameters for regressable user actions to the regression stack 212 of the regression manager 202.

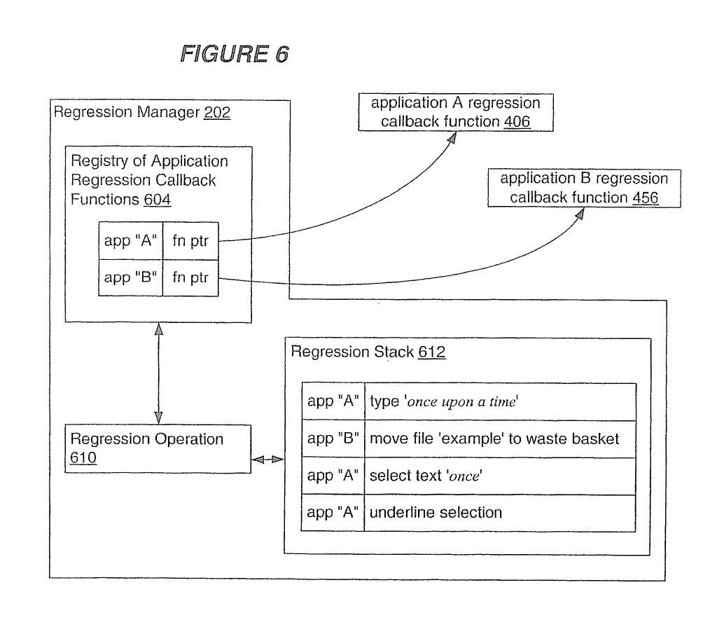

FIG. 6 is block diagram of the regression manager 202 of FIG. 2 in use for the software applications ‘A’ 402 and ‘B’ 452 of FIG. 4 following the operations 502 to 532 of the state diagram in FIG. 5 in accordance with a preferred embodiment of the present invention. Many of the elements of FIG. 6 are identical to those described above with respect to FIG. 2 except insofar as the elements of FIG. 6 are configured to reflect the state of the regression manager 202 following the operations 502 to 532 of FIG. 5. The registry 604 comprises two entries: an entry for software application ‘A’ 402 having a function pointer to the regression callback function 406 of software application ‘A’ 402; and an entry for software application ‘B’ 452 having a function pointer to the regression callback function 456 of software application ‘B’ 452. The regression stack 612 includes an entry having an application identifier and an action parameter for each of the user actions of FIG. 5. The entries are ordered such that the action parameters corresponding to the least recent actions are at the top, and the action parameters corresponding to the most recent actions are at the bottom.

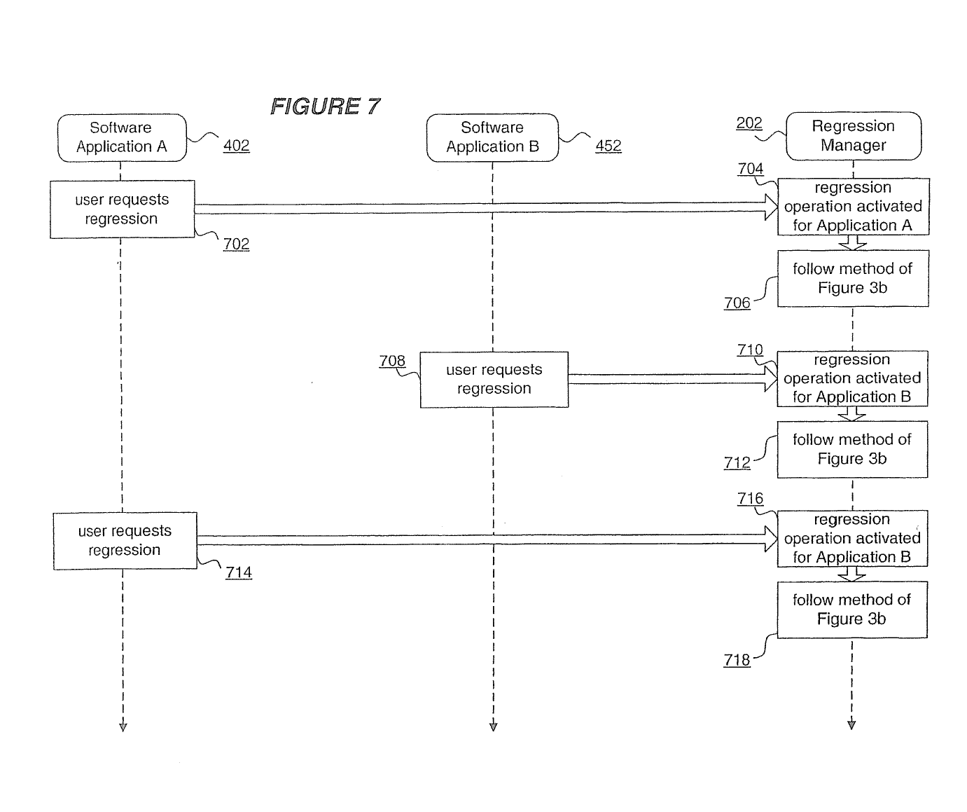

FIG. 7 is a second state diagram of the software applications of FIG. 4 in use with the regression manager 202 of FIG. 6 to regress actions in the regression stack 612 in accordance with a preferred embodiment of the present invention. At 702, a user of software application ‘A’ 402 requests a regression operation. The request is notified to the regression manager 202 which activates the regression operation 210 at 704 following the method of FIG. 3b at 706. Referring back to FIG. 3b, at step 352 the regression operation 210 receives the application identifier of software application ‘A’ 402. At step 354 the regression operation 210 locates a most recent entry in the regression stack 612 for the application identifier ‘A’ and identifies the action parameter “underline selection”. At step 356 the regression operation 210 locates a reference to the regression callback function 406 for software application ‘A’ 402 in the registry 604. Subsequently, at step 358, the regression operation 210 calls the regression callback function 406 with an argument of the action parameter “underline selection”, When called, the application callback function 406 operates to regress the “underline selection” action. Finally, at step 360, the method removes the most recent entry in the regression stack 612 for the software application ‘A’. FIG. 5a illustrates a transition of the regression stack 612 of FIG. 6 during the regression 702 to 706 of FIG. 7, indicating in bold the entry in the regression stack 612 which is removed.

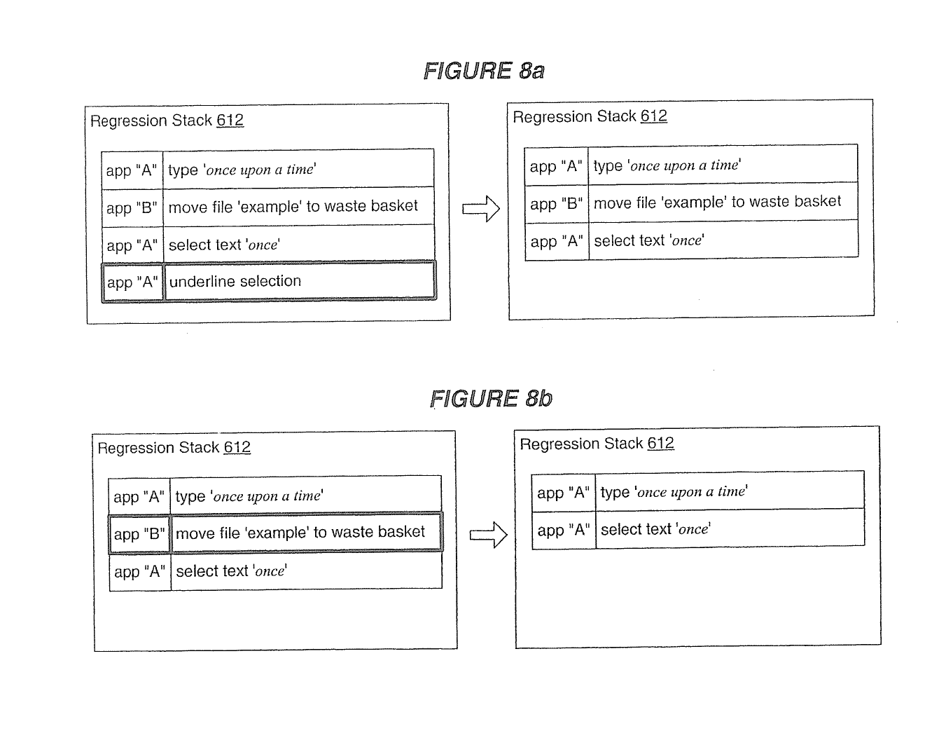

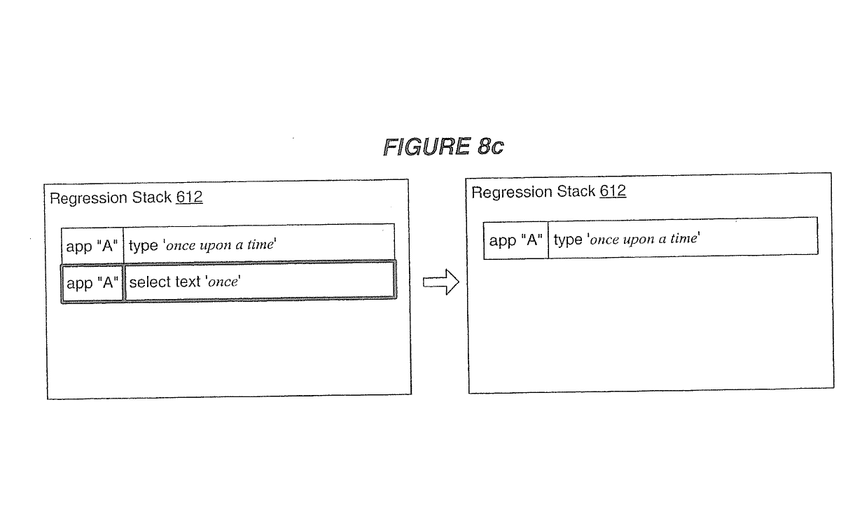

Returning now to FIG. 7, subsequently, at 708, a user of software application ‘B’ 452 requests a regression operation. The request is notified to the regression manager 202 which activates the regression operation 210 at 710 following the method of FIG. 3b at 712. Referring again to FIG. 3b, at step 352 the regression operation 210 receives the application identifier of software application ‘B’ 452. At step 354 the regression operation 210 locates a most recent entry in the regression stack 612 for the application identifier ‘B’ and identifies the action parameter ‘move file “example” from an “original location” to “waste basket”’. At step 356 the regression operation 210 locates a reference to the regression callback function 456 for software application ‘B’ 452 in the registry 604. Subsequently, at step 358, the regression operation 210 calls the regression callback function 456 with an argument of the action parameter ‘move file “example” from an “original location” to “waste basket”’. When called, the application callback function 456 operates to regress the ‘move file “example” from an “original location” to “waste basket”’ action. Finally, at step 360, the method removes the most recent entry in the regression stack 612 for the software application ‘B’. FIG. 8b illustrates a transition of the regression stack 612 of FIG. 6 during the regression 708 to 712 of FIG. 7, indicating in bold the entry in the regression stack 612 which is removed.

Returning now to FIG. 7, subsequently, at 714, a user of software application ‘A’ 402 requests a regression operation. The request is notified to the regression manager 202 which activates the regression operation 210 at 716 following the method of FIG. 3b at 718. Referring back to FIG. 3b, at step 352 the regression operation 210 receives the application identifier of software application ‘A’ 402. At step 354 the regression operation 210 locates a most recent entry in the regression stack 612 for the application identifier ‘A’ and identifies the action parameter ‘select text “once”’. At step 356 the regression operation 210 locates a reference to the regression callback function 406 for software application ‘A’ 402 in the registry 604. Subsequently, at step 358, the regression operation 210 calls the regression callback function 406 with an argument of the action parameter ‘select text “once”’. When called, the application callback function 406 operates to regress the ‘select text “once”’ action. Finally, at step 360, the method removes the most recent entry in the regression stack 612 for the software application ‘A’. FIG. 5c illustrates a transition of the regression stack 612 of FIG. 6 during the regression 714 to 718 of FIG. 7, indicating in bold the entry in the regression stack 612 which is removed.

Insofar as embodiments of the invention described are implementable, at least in part, using a software-controlled programmable processing device, such as a microprocessor, digital signal processor or other processing device, data processing apparatus or system it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk, or other computer-readable medium, and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the above described example embodiments, the invention is not limited thereto and that there are many possible variations and modifications which fall within the scope of the invention.

The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A method of a regression manager for providing a regression operation to a software application executable in a computer system, the method comprising the steps of:
receiving registration information for a regression callback function from a software application, the regression callback function providing a regression facility for the software application;
receiving an action parameter for a regressable action from the software application, the action parameter comprising an argument for use by the regression callback function to regress the regressable action; and
in response to a request to provide a regression operation for the software application, calling the regression callback function for the software application.

2. The method of claim 1, further comprising storing each of the action parameters associated with an identifier of the software application in a data structure ordered according to the order of receipt of action parameter.

3. The method of claim 2, wherein the calling the regression callback step further comprises sending an argument of a most recent of the action parameters associated with the software application.

4. The method of claim 3 further comprising removing the most recent of the action parameters associated with the software application from the data structure.

5. The method of claim 3 further comprising incorporating the regression manager into an operating system of the computer system.

6. The method of claim 3, further comprising configuring the data structure as a stack data structure.

7. The method of claim 6, further comprising storing the stack in a memory of the computer system.

8. The method of claim 7, wherein the storing comprises storing the stack in a non-volatile memory of the computer system such that action parameters are persistent.

9. The method of claim 3, wherein the request to provide a regression operation originates from a source logically separated from the software application.

10. A regression manager apparatus for providing a regression operation to a software application executable in a computer system, the apparatus comprising:
a first receiver for receiving registration information for a regression callback function from a software application, the regression callback function providing a regression facility for the software application;
a second receiver receiving an action parameter for a regressable action from the software application, the action parameter comprising an argument for use by the regression callback function to regress the regressable action; and
a function caller for, in response to a request to provide a regression operation for the software application, calling the regression callback function for the software application.

11. The apparatus of claim 10, further comprising a storer for storing each of the action parameters associated with an identifier of the software application in a data structure ordered according to the order of receipt of action parameter.

12. The apparatus of claim 11, wherein the function caller is further operable to send an argument of a most recent of the action parameters associated with the software application.

13. The apparatus of claim 12, further comprising a parameter remover for removing the most recent of the action parameters associated with the software application from the data structure.

14. The apparatus of claim 12 wherein the data structure is a stack data structure.

15. The apparatus of claim 14, wherein the stack is stored in a memory of the computer system.

16. The apparatus of claim 15, Wherein the stack is stored in a non-volatile memory of the computer system such that action parameters are persistent.

17. The apparatus of claim 12, wherein the request to provide a regression operation originates from the software application.

18. The apparatus of claim 12, wherein the request to provide a regression operation originates from a source logically separated from the software application.

19. A computer system comprising:
a central processing unit:
a memory subsystem;
an input/output subsystem;
a bus subsystem interconnecting the central processing unit, the memory subsystem, the input/output subsystem; and
an apparatus configured to operate in conjunction with the central processing unit for providing a regression operation to a software application executable in the computer system, the apparatus being further configured to:
receive registration information for a regression callback function from a software application, the regression callback function providing a regression facility for the software application,
receive an action parameter for a regressable action from the software application, the action parameter comprising an argument for use by the regression callback function to regress the regressable action, and
in response to a request to provide a regression operation for the software application, call the regression callback function for the software application.

20. A computer-readable medium comprising computer program code that, when loaded into a computer system and executed thereon, causes the computer to perform the steps of:
receiving registration information for a regression callback function from a software application, the regression callback function providing a regression facility for the software application;
receiving an action parameter for a regressable action from the software application, the action parameter comprising an argument for use by the regression callback function to regress the regressable action; and
in response to a request to provide a regression operation for the software application, calling the regression callback function for the software application.
